(19) United States
(12) Patent Application Publication
(10) Pub. No.: US 2004/0122831 A1
(43) Pub. Date: Jun. 24, 2004

(54) Component-based automatic document generation system and method

(76) Inventors: Young-Gook Ha, Daejeon (KR); Sang-Seung Kang, Daegoo (KR); Cheon-Shu Park, Daejeon (KR); Woo-Yong Han, Daejeon (KR); Joo-Chan Sohn, Daejeon (KR); Duk-Joo Son, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/614,953

(22) Filed: Jul. 8, 2003

(30) Foreign Application Priority Data
Dec. 24, 2002 (KR) 2002-83736

(51) Int. Cl. G06F 7/00

(52) U.S. Cl. 707/100

(57) ABSTRACT

A system and method for automatically generating documents used in an Internet e-business environment. In the present invention, using document components that may be jointly used between e-business systems and that are stored in a document component library, a document generation rule formulating tool based on a graphic user interface is employed to generate business documents. Document components are assembled based on these rules, after which context rules are applied to revise the assembled components to match desired conditions to thereby generate grammar neutral documents. Finally, conversion is performed into grammar for a specific business system to generate business documents. As a result, the differences between business systems are overcome, and the re-usability of business documents is maximized to enable e-business to be performed efficiently.

### CROSS REFERENCE TO RELATED APPLICATION

This application is based on Korea Patent Application No. 2002-83736 filed on Dec. 24, 2002 in the Korean Intellectual Property Office, the content of which is incorporated herein by reference.

### BACKGROUND OF THE INVENTION

(a) Field of the Invention

The present invention relates to a system and method for automatically generating electronic documents used in an e-business environment. More particularly, the present invention relates to a system and method that generates documents that allow re-usability of electronic business documents and provides for compatibility between different business domains based on document components, which are stored in a document component library that may be jointly used by different e-business systems.

(b) Description of the Related Art

In Internet-based e-business, electronic documents such as “product catalogs”, “purchase request forms”, and “purchase request reply forms” are sent and received between parties (performing a business transaction) through the Internet using established procedures.

Documents needed to perform business transactions vary greatly and may be extremely complicated depending on various factors such as geopolitical location, product classification, and business role or industry classification. Such factors are referred to as business context.

For example, in a conventional e-business environment, if the parties involved are from different countries, the monetary units and exchange rates used in the business documents are different, and distinct expressions may be used for different industries and may even mean different things for different industries.

Therefore, in a conventional e-business environment, if the business environments of parties involved in a business transaction are dissimilar, it is possible for the different parties to have contrasting interpretations of the expressions used in the business documents.

Further, there are instances when in different business domains, the same business documents or business documents having identical portions are designated and used for business transactions.

If such difficulties are encountered in large and various business domains, the costs associated with storing and managing documents increase, and the business becomes complicated. Overall efficiency is reduced as a result.

### SUMMARY OF THE INVENTION

It is an advantage of the present invention to provide a system and method in which document components are designated and stored in a document component library that may be jointly used in each business system, and necessary components are accumulated and automatically assembled based on assembly rules and context rules in a document generation rule formulator.

Further, differences between systems are overcome with respect to performing e-business, and re-usability of business documents is maximized to enable e-business to be performed efficiently.

In one aspect of the present invention, an automatic document generation system in an e-business environment includes a document generation rule formulator that a user employs to designate document generation rules through a graphic user interface; a document component library storing and managing document component summary information and document components that represent specific concepts; a document generation rule processor accumulating document components needed for document assembly and that are received from the document component library, and generating grammar neutral document objects, the document generation rule processor performing these operations on the basis of document generation rules; and a document grammar connector that converts the grammar neutral document objects, which are suitable for processing in a computer system, into grammar-connected documents that are in a string form for use in an actual business.

The present invention maximizes the re-usability of business documents, and uses components as building blocks that may be re-used and that form documents to thereby allow cooperation between different businesses.

The documents express specific concepts that are independent of each other. That is, the document component “postal address” refers to a mailing address but, depending on the circumstances, may mean the “sender address”, the “receiver address”, the “business address”, “home address”, etc.

For example, a document component having the meaning of “sender address” in one business domain may have the meaning of “business address” in another business domain. This may cause problems if the different parties involved interpret “sender address” differently. However, if the same “address” document component is used, no confusion will arise.

In another aspect of the present invention, an automatic document generation method in an e-business environment includes storing document component summary information and document components that represent specific concepts; designating document generation rules through a graphic user interface; accumulating document components needed for document assembly from a document component library, and generating grammar neutral document objects based on the document generation rules; and converting the grammar neutral document objects, which are suitable for processing in a program of a computer system, into grammar-connected documents in a string form used in an actual business.

### BRIEF DESCRIPTION OF THE DRAWINGS

The accompanying drawings, which are incorporated in and constitute a part of the specification, illustrate an embodiment of the invention, and together with the description, serve to explain the principles of the invention:

FIG. 1 is a schematic view of a component-based automatic document generation system according to an embodiment of the present invention.

FIG. 2 is a schematic view of a document component library of FIG. 1.

FIG. 3 is a schematic view of a document generation rule formulator of FIG. 1.

FIG. 4 is a schematic view of a document generation rule processor of FIG. 1.

FIG. 5 is a flow chart of an operation for processing assembly rules in a component assembler of FIG. 4.

FIG. 6 is a flow chart of an operation for processing context rules in a context processor of FIG. 4.

FIG. 7 is a schematic view of a document grammar connector of FIG. 1.

### DETAILED DESCRIPTION OF THE PREFERRED EMBODIMENTS

An embodiment of the present invention will now be described in detail with reference to the accompanying drawings.

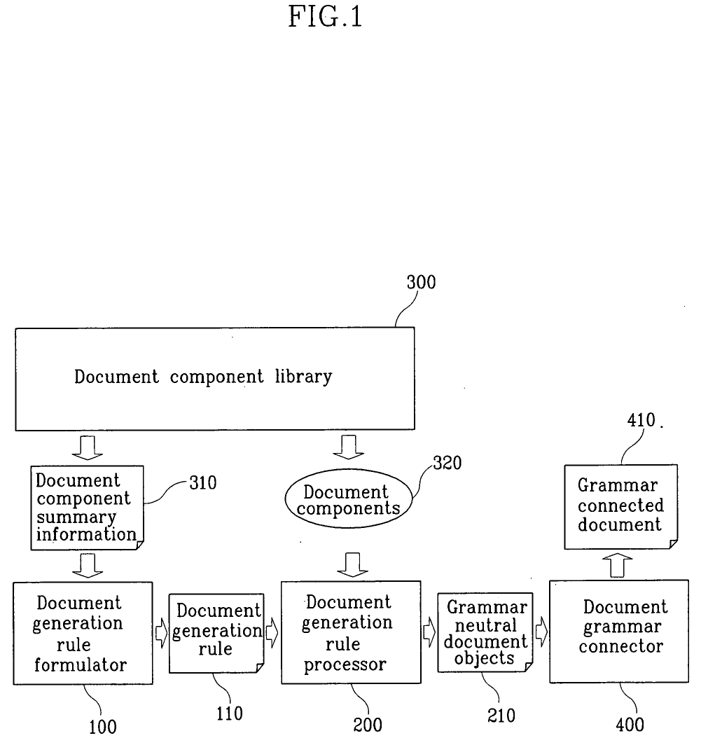

FIG. 1 is a schematic view of a component-based automatic document generation system according to an embodiment of the present invention.

With reference to the drawing, in order to generate business documents, a user first uses a document generation rule formulator 100 to generate document generation rules 110.

The document generation rule formulator 100 is a tool that allows users to conveniently designate document generation rules through a graphic user interface.

Further, the document generation rule formulator 100 searches document component summary information 310 in a document component library 300 to formulate the document generation rules 110.

The generated document generation rules 110 are used by a document generation rule processor 200 to generate grammar neutral document objects 210.

During this process, the document generation rule processor 200 accumulates and uses document components 320, which are required for document assembly, from the document component library 300.

Lastly, the grammar neutral document objects 210, which are in a suitable form for processing by a program of a computer system, are converted by a document grammar connector 400 into a grammar connected document 410. The grammar connected document 410 is in the form of a string, which is recognizable by the user.

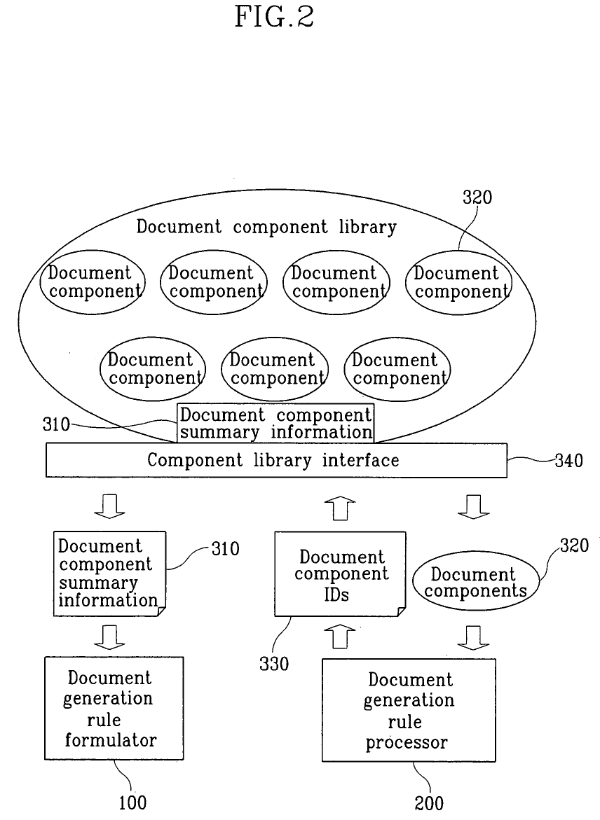

FIG. 2 is a schematic view of the document component library 300 of FIG. 1.

The document component library 300 is a public storage area for storing and managing document components that can be jointly used in each business system.

The document component library 300 stores a variety of the document components 320 that constitute business documents, and the document component summary information 310 that records detailed information with respect to all the components included in the present library.

Further, the document component library 300 includes a component library interface 340 for connection to external modules. The document generation rule formulator 100 searches the document component summary information 310 through the component library interface 340, and the document generation rule processor 200 uses document component IDs 330, which are numbers specific to each component, to accumulate document components required for document assembly.

The document components of the embodiment of the present invention are simple components of a single type and complex components realized through a plurality of simple components.

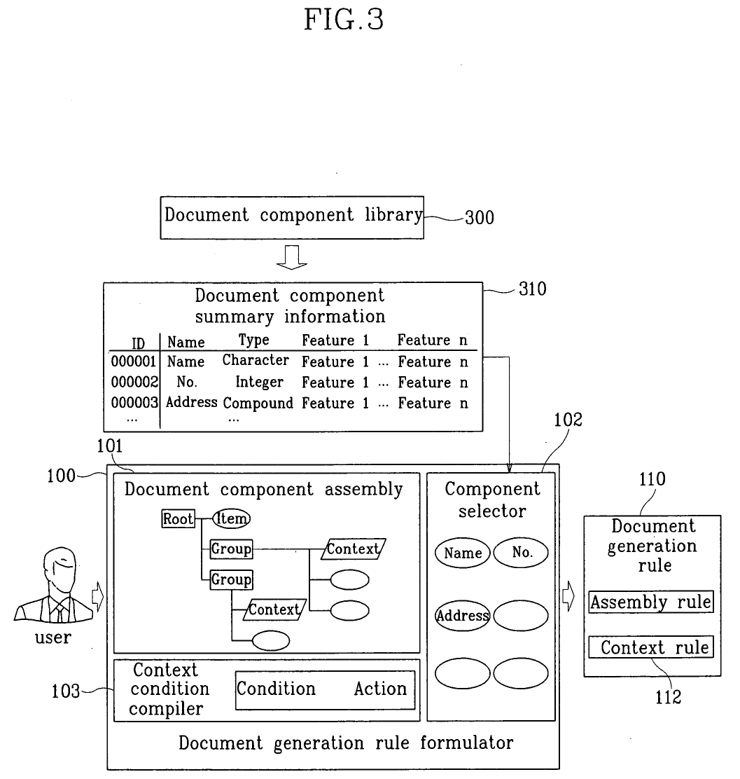

FIG. 3 is a schematic view of the document generation rule formulator 100 of FIG. 1.

The document generation rule formulator 100 is a tool that allows users to conveniently designate document generation rules through a graphic user interface as described above. As shown in the drawing, the document generation rule formulator 100 includes a document component assembler 101, a component selector 102, and a context condition compiler 103.

Based on the document component summary information 310 searched in the document component library 300, the component selector 102 displays usable component items that are provided by a corresponding library.

The contents of the document component summary information 310 must necessarily include component IDs, component names, and component type, and may also include various different types of information that represent other components.

The document component assembler 101 is an area where component structures are modeled based on user input through a graphic user interface. The user drags the needed document components appearing in the component selector 102 and drops them at a suitable location in the document component assembler 101 to thereby generate document structures. Such structures are formulated as assembly rules 111.

The assembly rules 111 include IDs of all document components and structural information between each component. The context condition compiler 103 is an area where context conditions realized through pairs of conditions and actions are compiled to enable insertion into document structures. The context condition compiler 103 enables the formulation of context rules 112, which allow the processing of actions, in the document generation rule processor 200 in the case where conditions are satisfied for a specific business context during document assembly.

The assembly rules and context rules are output as a single document generation rule 110.

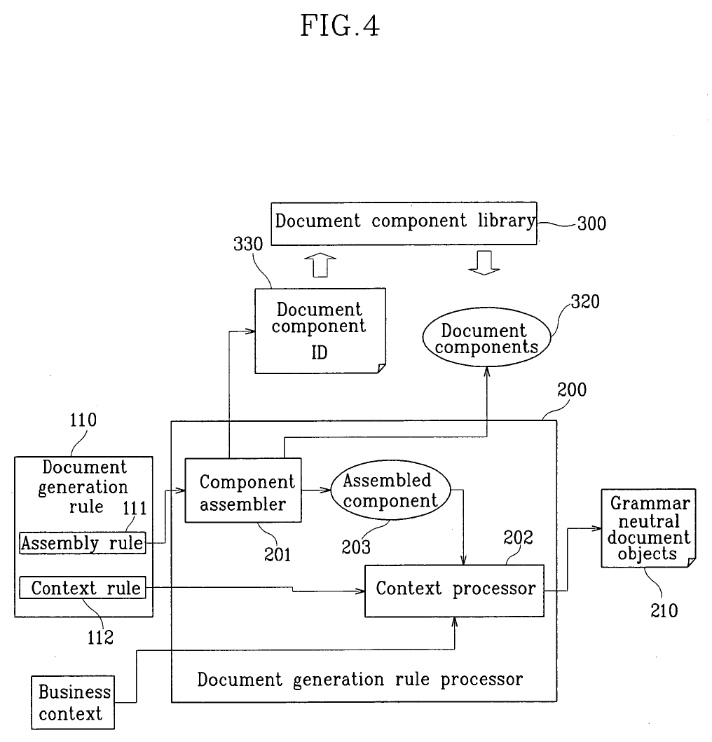

FIG. 4 is a schematic view of the document generation rule processor 200 of FIG. 1.

The document generation rule processor 200 is a module for generating the grammar neutral document objects 210 based on the document generation rules 110 made in the document generation rule formulator 100. As shown in FIG. 4, the document generation rule processor 200 includes a component assembler 201 that processes the assembly rules 111, and a context processor 202 that processes the context rules 112.

The component assembler 201 reads assembly rules in the document generation rules 110, and using the document component IDs 330, accumulates from the document component library 300 the document components 320 required in the assembly rules. The component assembler 201 then assembles the document components 320 using the structural information between components, after which the resulting assembled components 203 are output.

The context processor 202 reads context rules in the document generation rules 110, and if a specific business context 220 satisfies the conditions of the context rules, applies the designated actions in the assembled components to thereby ultimately generate the grammar neutral document objects 210.

As an example of a context condition, “Condition(Geopolitical=‘IT’), Rename(‘Address’, ‘Indirizzo’)” is an instruction to change, in the case where the geopolitical environment of the business document is Italy(IT), the component name of ‘Address’ in the assembled component structure to ‘Indirizzo’, which means address in the Italian language.

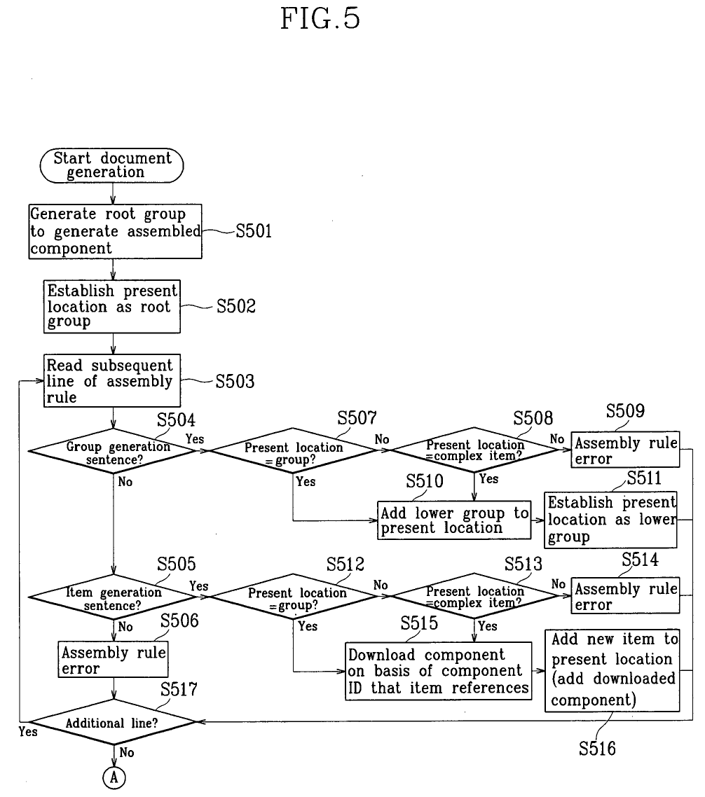

FIG. 5 is a flow chart of an operation for processing the assembly rules 111 in the component assembler 201 of FIG. 4. The detailed processes involved in reading the assembly rules 111 and assembling the document components 320 are illustrated in the flow chart.

The component assembler 201 generates a root group to generate an assembly component in step S501.

Next, the component assembler 201 establishes the present location as the root group in step S502, reads a subsequent line of an assembly rule in step S503, and determines if it is a group generation sentence in step S504.

If not a group generation sentence, the component assembler 201 determines if the next line of the assembly rule is an item generation sentence in step S505. If the next line of the assembly rule is not an item generation sentence, the component assembler 201 determines that there is an assembly rule error in step S506.

On the other hand, if the next line of the assembly rule is a group generation sentence, the component assembler 201 determines if the present location is a group in step S507. If the present location is a group, the component assembler 201 adds a lower group to the present location in step S510, and establishes the present location as the lower group in step S511.

If the present location is not a group, the component assembler 201 determines if the present location is a complex item in step S508. If the present location is not a complex item, the component assembler 201 determines that there is an assembly rule error in step S509.

If the present location is a complex item, the component assembler 201 adds a lower group to the present location in step S510, and establishes the present location as the lower group in step S511.

In step S505, if the line that is read is an item generation sentence, the component assembler 201 determines if the present location is a group in step S512. If the present location is a group, the component assembler 201 downloads a component on the basis of a component ID that an item references in step S515, then adds the component downloaded to the present location as a new item in step S516.

If the present location is not a group, the component assembler 201 determines if the present location is a complex item in step S513. If the present location is a complex item, the component assembler 201 performs steps S515 and S516 respectively of downloading a component on the basis of a component ID that an item references and adding the component downloaded to the present location as a new item.

However, if the present location is not a complex item, the component assembler determines that there is an assembly rule error in step S514.

After the completion of any one of the steps S509, S511, S514, S516, and S506, the component assembler 201 determines if there is an additional line in step S517. If there is an additional line, the process is repeated starting with step S503. If there is no additional line, control is given to the context processor 202.

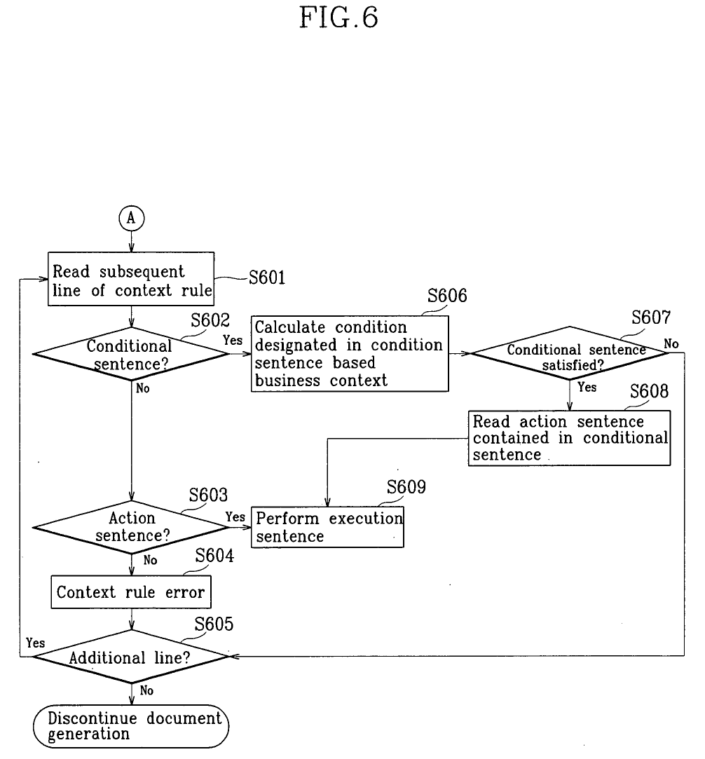

FIG. 6 is a flow chart of an operation for processing the context rules 112 in the context processor 202 of FIG. 4. The detailed processes involved in reading the context rules 112 and generating the document objects 210 are illustrated in the flow chart.

The context processor 202 reads a subsequent line of a context rule in step S601, and determines if it is a conditional sentence in step S602.

If the subsequent line of a context rule is a conditional sentence, the context processor 202 calculates a condition designated in the conditional sentence based on the business context in step S606, then determines if the conditional sentence is satisfied in step S607.

If the conditional sentence is satisfied, the context processor 202 reads an action sentence contained in the conditional sentence in step S608, then performs an execution sentence designated in the action sentence in step S609.

If the line that is read is not a conditional sentence in step S602, the context processor 202 determines if the read line is an action sentence in step S603.

If the read line is an action sentence, the context processor 202 performs an execution sentence designated in the action sentence in step S609.

However, if the read line is not an action sentence, the context processor 202 determines that there is a context rule error in step S604.

Following any one of steps S604, S609, S607, and S608, the context processor 202 determines if there is an additional line in step S605. If there is an additional line, the process is repeated starting from step S601, while if there is no additional line, document generation is discontinued.

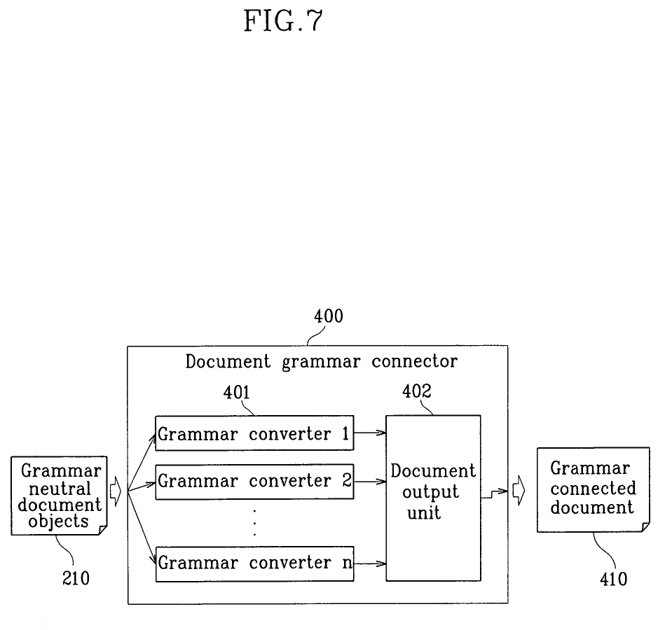

FIG. 7 is a schematic view of the document grammar connector 400 of FIG. 1.

With reference to the drawing, the grammar neutral document object 210 generated in the document generation rule processor 200 is a memory structural object in a form suitable for processing in a program of a computer system. The grammar neutral document object 210 is converted into a grammar-connected document object through a grammar converter 401, which supports grammar (e.g., XML schema, XML DTD, EDI MIG) suitable for a specific business system. Next, the grammar neutral document object 210 is made into a grammar-connected document 410 through a document output unit 402. The grammar-connected document 410 is used in an actual business and is in the form of a string recognizable by a user.

In the embodiment of the present invention described above, the differences between business systems are overcome with respect to performing e-business, and the re-usability of business documents is maximized to enable e-business to be performed efficiently.

Although an embodiment of the present invention has been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An automatic document generation system in an e-business environment, comprising:
a document generation rule formulator that a user employs to designate document generation rules through a graphic user interface;
a document component library for storing and managing document component summary information and document components that represent specific concepts;
a document generation rule processor for accumulating document components needed for document assembly received from the document component library, and generating grammar neutral document objects, the document generation rule processor performing these operations on the basis of document generation rules; and
a document grammar connector for converting the grammar neutral document objects, which are suitable for program processing in a computer system, into grammar-connected documents that are in a string form for use in an actual business.

2. The system of claim 1, wherein the document generation rule formulator comprises:
a component selector for displaying usable component items that are provided by a corresponding library based on document component summary information searched in the document component library, the document component summary information including at least a component ID, a component name, and a component type, and optionally including various different types of information that represent other components;
a document component assembler for forming an area where component structures are modeled based on user input through a graphic user interface, the user dragging the needed document components appearing in the component selector and dropping the documents at a suitable location in the document component assembler to thereby generate document structures, in which such structures are formulated as assembly rules, and the assembly rules include IDs of all document components and structural information between each component; and
a context condition compiler for forming an area where context conditions realized through pairs of conditions and actions are compiled to enable insertion into document structures, the context condition compiler enabling the formulation of context rules, which allow the processing of actions, in the document generation rule processor in the case where conditions are satisfied for a specific business context during document assembly.

3. The system of claim 2, wherein the assembly rules and the context rules are output as a single document generation rule.

4. The system of claim 1, wherein the document component library comprises:
the document component summary information for recording various document components that constitute business documents and detailed information on all components included in a present library; and
a component library interface for connection to external modules,
wherein the document generation rule formulator searches the document component summary information through the component library interface, and the document generation rule processor uses document component IDs, which are numbers specific to each component, to accumulate document components required for document assembly.

5. The system of claim 4, wherein the document components stored in the document component library include simple components of a single type and complex components realized through a structure of a plurality of simple components.

6. The system of claim 1, wherein the document generation rule processor comprises:
a component assembler for reading assembly rules in the document generation rules, and using document component IDs to accumulate from the document component library the document components required in the assembly rules, then assembling the document components using structural information between components, after which the resulting assembled components are output; and
a context processor for reading context rules in the document generation rules, and, if a specific business context satisfies the conditions of the context rules, applying designated actions to the assembled components to thereby ultimately generate the grammar neutral document objects.

7. The system of claim 1, wherein the document grammar connector comprises:
a grammar converter supporting grammar for supporting specific business systems, and converting the grammar neutral document objects into grammar-connected document objects; and
a document output unit for realizing and storing grammar-connected documents, which are used in an actual business and are in the form of a string recognizable by a user.

8. An automatic document generation method in an e-business environment, comprising:
(a) storing document component summary information and document components that represent specific concepts;
(b) designating document generation rules through a graphic user interface;
(c) accumulating document components needed for document assembly and from a document component library, and generating grammar neutral document objects based on the document generation rules; and
(d) converting the grammar neutral document objects, which are suitable for processing in a program of a computer system, into grammar-connected documents in a string form used in an actual business.

9. The method of claim 8, wherein (b) comprises:
displaying a list of usable components provided by a corresponding library based on the document component summary information searched in the document component library;
dragging required documents appearing in a component selector and dropping the documents at a suitable location in a document component assembler, which forms an area where component structures are modeled based on user input through a graphic user interface, to thereby generate document structures; and
compiling context conditions realized through pairs of conditions and actions, and allowing insertion of the context conditions into document structures.

10. The method of claim 8, wherein (c) comprises:
reading assembly rules in the document generation rules, accumulating from the document component library the document components required in the assembly rules using document component IDs, assembling the document components using structural information between components, and outputting the resulting assembled components; and
reading context rules in the document generation rules, and if a specific business context satisfies the conditions of the context rules, applying designated actions to the assembled components to thereby ultimately generate the grammar neutral document objects.

11. The method of claim 8, wherein (d) comprises:
supporting grammar for specific business systems and converting the grammar neutral document objects into grammar-connected document objects; and
realizing and storing grammar-connected documents, which are used in an actual business and are in the form of a string recognizable by a user.

12. Recording media storing an e-business document generation method, comprising:
storing document component summary information and document components that represent specific concepts;
designating document generation rules through a graphic user interface;
accumulating document components needed for document assembly from a document component library, and generating grammar neutral document objects based on the document generation rules; and
converting the grammar neutral document objects, which are suitable for processing in a program of a computer system, into grammar-connected documents in a string form used in an actual business.
